(19) United States
(12) Patent Application Publication
(10) Pub. No.: US 2025/0328033 A1
(43) Pub. Date: Oct. 23, 2025

(54) COMPACT POLARIZATION-DEPENDENT FARADAY ISOLATOR

(71) Applicant: Electro-Optics Technology, Incorporated, Traverse City, MI (US)

(72) Inventors: Larry JONES, Traverse City, MI (US); Joseph MAMBOURG, Spring Lake, MI (US); David SCERBAK, Traverse City, MI (US); Conor BYRNE, Traverse City, MI (US)

(73) Assignee: Electro-Optics Technology, Incorporated, Traverse City, MI (US)

(21) Appl. No.: 18/638,010

(22) Filed: Apr. 17, 2024

(51) Int. Cl. G02F 1/01; G02F 1/09

(52) U.S. Cl. CPC G02F 1/0136; G02F 1/09

(57) ABSTRACT

A polarization-dependent Faraday isolator, imposing both non-reciprocal and reciprocal polarization rotation, implements the polarizing and polarization-rotating optical elements as a solid block with coatings. The solid block includes a Faraday crystal. A forward-propagating laser beam enters the solid block via an input surface, undergoes total internal reflection at a side surface, and leaves the solid block via an output surface. Polarizing input- and output-coatings are disposed on the input and output surfaces, respectively. A phase-shifting coating is disposed on the first side surface and introduces a phase shift between s-polarized and p-polarized beam components of the forward-propagating laser beam during total internal reflection at the first side surface, resulting in reciprocal polarization rotation. The Faraday isolator can be made very compact and eliminates the need for separate alignment of the different optical elements. The Faraday isolator may be configured for net-zero overall polarization rotation of the forward-propagating laser beam.

### TECHNICAL FIELD OF THE INVENTION

The present invention relates in general to polarization-dependent Faraday isolators that impose both non-reciprocal and reciprocal polarization rotation, such as Faraday isolators configured to transmit the forward-propagating laser beam with net-zero overall polarization rotation. The present invention relates in particular to overcoming issues associated with miniaturizing such Faraday isolators.

### DISCUSSION OF BACKGROUND ART

Backward propagation of laser light toward a laser source can destabilize laser operation or even damage the laser source. Backward-propagating laser light is often produced by Fresnel reflections of the forward-propagating laser beam by optical elements used to manipulate the laser beam. Backward-propagating laser light may also be produced by Fresnel reflections at a workpiece processed by the laser beam or at a sample interrogated by the laser beam. Depending on the type of laser source and the power of the forward-propagating laser beam, back-reflection of even a small fraction of the forward-propagating laser beam may be sufficient to destabilize or damage the laser source.

Back-reflection of a laser beam by optical elements can be suppressed by coating optical surfaces with anti-reflection coatings or orienting the optical elements at non-normal incidence with respect to the forward-propagating laser beam. Such mitigation techniques may, however, be insufficient or incompatible with other requirements of the laser apparatus. Additionally, these mitigation techniques do not protect against back-reflections from workpieces or other objects placed in the laser beam intentionally or unintentionally. In many cases, it is therefore desirable or necessary to implement an “optical isolator” in the laser beam path. The optical isolator transmits the forward-propagating laser beam with relatively high efficiency while imposing a high propagation loss on any backward-propagating components of the laser beam. Ideally, backward-propagating beam components are rejected entirely by the optical isolator.

The most widely used type of optical isolator is a “Faraday isolator” that utilizes the Faraday effect in a “Faraday rotator” to allow forward propagation while rejecting backward propagation (at least to some degree). A Faraday rotator is a Faraday crystal subjected to a strong magnetic field. The magnetic field is usually parallel to the optical axis of the Faraday crystal. Consider a linearly polarized forward-propagating laser beam. The Faraday rotator of a Faraday isolator rotates the polarization of this forward-propagating beam by 45 degrees. The polarization-rotation effect in a Faraday rotator differs from that in a half-wave plate by being non-reciprocal. That is, the polarization rotation is not undone by a second, backwards pass through the Faraday crystal. Instead, a back-reflected beam component is rotated an additional 45 degrees. Thus, at the input face of the Faraday crystal, a backward-reflected beam component is polarized orthogonally to the original forward-propagating beam.

In its simplest version, the Faraday isolator is realized by placing polarizers on both sides of the Faraday crystal, with their respective orientations being 45 degrees apart so as to transmit the forward-propagating beam. The polarizer on the input side of the Faraday crystal then rejects back-reflected beam components. This Faraday rotator is polarization-dependent in that the polarizers are configured to transmit a particular polarization component in the forward direction. For convenience, a typical Faraday isolator further includes a half-wave plate between the polarizers. The half-wave plate imposes a reciprocal polarization rotation of 45 degrees to ensure a net-zero overall polarization rotation of the forward-propagating laser beam.

### SUMMARY OF THE INVENTION

A conventional polarization-dependent Faraday isolator with net-zero overall polarization rotation of the forward-propagating laser beam contains a permanent magnet and four separate optical components: a Faraday crystal, two polarizers, and a half-wave plate. The laser beam propagates in free space between these four optical components. This conventional Faraday isolator is typically relatively large and may be one of the largest components of a laser apparatus. The miniaturization of conventional optical systems is often achieved by replacing conventional optical elements with corresponding micro-optical elements. However, miniaturizing the design of this conventional Faraday isolator by using micro-optics presents challenges. Such a miniaturized Faraday isolator would need at least four separate micro-optical elements, each of which is difficult to handle, clean, and align. The alignment and cleanliness of the individual micro-optical elements may be critical to the performance of the Faraday isolator and, especially, its ability to protect a laser source from undesirable back-reflections.

Disclosed herein is a polarization-dependent Faraday isolator with both non-reciprocal and reciprocal polarization rotation, in which the polarizing and polarization-rotating optical elements are integrally formed. The present Faraday isolator can be made very compact and eliminates the need for separate alignment of the different optical elements. The Faraday isolator may be configured such that the reciprocal polarization rotation ensures net-zero overall polarization rotation of the forward-propagating laser beam.

The optical elements of the present Faraday isolator are implemented as a single solid block with coatings. The single solid block includes a Faraday crystal. The single solid block may be a monolithic Faraday crystal or include two or more different elements affixed to each other, e.g., a Faraday crystal and a beam-directing prism. In operation, the forward-propagating laser beam enters the solid block through an input surface and leaves the solid block via an output surface. Each of the input and output surfaces is coated with a polarizing coating.

During propagation in the solid block from the input surface to the output surface, the beam passes through the Faraday crystal and undergoes total internal reflection at one or more surfaces of the solid block. The Faraday crystal imposes non-reciprocal polarization rotation on the beam. Total internal reflection introduces a phase shift between p-polarized and s-polarized beam components. At least one surface of the solid block (e.g., a side surface), where the laser beam undergoes total internal reflection, is coated with a phase-shifting coating. The phase-shifting coating (or coatings) is configured such that the total internal reflection in the solid block imposes reciprocal polarization rotation on the beam. In one example, the phase shift introduced by the phase-shifting coating(s) results in the Faraday isolator transmitting the forward-propagating laser beam with net-zero overall polarization rotation.

In one aspect of the invention, a polarization-dependent Faraday isolator includes a solid block, a polarizing input-coating, a phase-shifting coating, and a polarizing output-coating. The solid block has an input surface, an output surface, and a first side surface. The solid block includes a Faraday crystal. The polarizing input-coating is disposed on the input surface. The phase-shifting coating is disposed on the first side surface and is configured to introduce a phase shift between s-polarized and p-polarized components of a laser beam, with respect to the first side surface, when the laser beam undergoes total internal reflection at the first side surface. The polarizing output-coating is disposed on the output surface.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 schematically illustrates a polarization-dependent Faraday isolator that implements the polarizing and polarization-rotating optical elements as a single solid block with coatings, according to an embodiment.

FIG. 2 schematically illustrates, in cross-sectional view, another polarization-dependent Faraday isolator that implements the polarizing and polarization-rotating optical elements as a single solid block with coatings, according to an embodiment. This Faraday isolator is configured to operate with colinear input and output laser beams.

FIG. 3 is a cross section of a polarization-dependent Faraday isolator that implements the polarizing and polarization-rotating optical elements as a monolithic Faraday crystal with coatings, according to an embodiment.

FIG. 4 is a cross section of a polarization-dependent Faraday isolator that implements optical elements as a composite solid block with coatings, according to an embodiment.

FIG. 5 schematically illustrates a polarization-dependent Faraday isolator that (a) implements the polarizing and polarization-rotating optical elements as a single solid block with coatings and (b) is configured for two total-internal-reflections in the solid block, according to an embodiment.

FIG. 6 schematically illustrates, in cross-sectional view, another polarization-dependent Faraday isolator that implements the polarizing and polarization-rotating optical elements as a single, coated solid block configured for two total-internal-reflections, according to an embodiment. This Faraday isolator is configured to operate with colinear input and output laser beams.

FIG. 7 is a cross section of a polarization-dependent Faraday isolator that implements the polarizing and polarization-rotating optical elements as a coated, rhomb-shaped Faraday crystal configured for two total-internal-reflections, according to an embodiment.

FIG. 8 is a cross section of a polarization-dependent Faraday isolator that implements the polarizing and polarization-rotating optical elements as a coated, composite solid block configured for two total-internal-reflections, according to an embodiment.

### DETAILED DESCRIPTION OF THE INVENTION

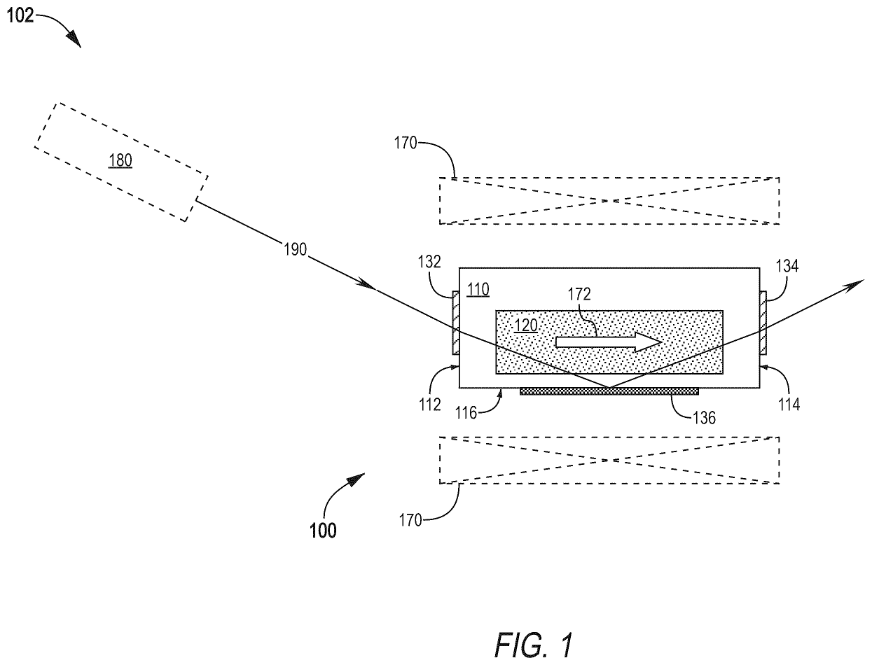

Referring now to the drawings, wherein like components are designated by like numerals, FIG. 1 schematically illustrates one polarization-dependent Faraday isolator 100 that implements the polarizing and polarization-rotating optical elements as a single solid block with coatings. Faraday isolator 100 includes a solid block 110, polarizing coatings 132 and 134, and a phase-shifting coating 136. Solid block 110 includes or is composed of a Faraday crystal 120. Solid block 110 has an input surface 112, an output surface 114, and a side surface 116. Although FIG. 1 depicts surfaces 112, 114, and 116 as being orthogonal to the plane of FIG. 1, this is not required. Polarizing coatings 132 and 134 are disposed on input surface 112 and output surface 114, respectively. Phase-shifting coating 136 is disposed on side surface 116.

Faraday isolator 100 may further include a magnet 170 that generates a magnetic field 172 in Faraday crystal 120. Magnetic field 172 is indicated schematically by an arrow in FIG. 1. The field axis of magnetic field 172 may be parallel to an optical axis of Faraday crystal 120. Embodiments of Faraday isolator 100 that do not include magnet 170 are intended to operate with a separately obtained magnet that generates magnetic field 172.

Faraday isolator 100 is configured to function as an optical isolator in a laser beam of a particular “design wavelength”. Optimization of Faraday isolator 100 for a particular design wavelength may be achieved through suitable material choices, dimensions, and surface orientations.

FIG. 1 shows Faraday isolator 100 as implemented in a laser apparatus 102 that further includes a laser source 180. In operation, laser source 180 produces a laser beam 190 that passes through solid block 110. In a typical scenario, beam 190 is collimated. Beam 190 enters solid block 110 via input surface 112 and leaves solid block 110 via output surface 114. During its propagation in solid block 110 from input surface 112 to output surface 114, beam 190 passes through Faraday crystal 120 and undergoes total internal reflection at side surface 116. The propagation path of beam 190 through solid block 110 is indicated only schematically in FIG. 1.

Beam 190 passes through polarizing coating 132 and enters solid block 110 via input surface 112. Polarizing coating 132 ensures that beam 190, upon entering solid block 110, is polarized along a polarization direction defined by polarizing coating 132. In a typical scenario, polarizing coating 132 transmits linearly polarized light of a particular polarization direction, and beam 190 is already nominally polarized along this selected polarization direction when incident on polarizing coating 132.

Faraday crystal 120 rotates the polarization of beam 190 in a non-reciprocal fashion. The configuration of Faraday isolator 100 is compatible with design wavelengths in several different wavelength ranges, with the material of Faraday crystal 120 being selected according to the design wavelength. In one implementation of Faraday isolator 100, Faraday crystal 120 is made of terbium gallium garnet (TGG), potassium terbium fluoride (KTF), or cadmium manganese telluride (CMT). This implementation of Faraday isolator 100 is compatible with design wavelengths at least in the ranges from 385 to 1400 nanometers (nm), and may be especially useful at design wavelengths in the range between 400 and 1100 nm. In another implementation of Faraday isolator 100, compatible at least with design wavelengths in the range between 1.9 and 2.1 micrometers (μm), Faraday crystal 120 is made of single-crystal silicon, rare-earth doped cubic fluoride such as magnesium fluoride (MgF₂) or barium fluoride (BaF₂), or rare-earth doped iron garnet such as bismuth iron garnet (BIG) or yttrium iron garnet (YIG). Yet another implementation of Faraday isolator 100 is compatible with design wavelengths in the range between 3 and 5 μm and in the range between 7 and 12 μm. In this implementation, Faraday crystal 120 may be made of indium arsenide (InAs) or indium antimonide (InSb).

The net non-reciprocal polarization rotation in Faraday crystal 120 is 45 degrees. More generally, the total non-reciprocal polarization rotation in Faraday crystal 120 is (45+N×90) degrees, wherein N is an integer. Any one of these total rotation angles will cause a back-reflected component of laser beam 190, completing a full backward pass through Faraday crystal 120, to be polarized orthogonally to the forward-propagating laser beam 190 when the back-reflected component reaches polarizing coating 132. Polarizing coating 132 will therefore reject this back-reflected component. However, a simple 45-degree rotation (N=0) is most easily achieved as this minimal rotation can be achieved with the smallest magnetic field. Thus, in most scenarios, Faraday isolator 100 is configured such that Faraday crystal 120 and magnet 170 cooperate to impose a 45-degree non-reciprocal polarization rotation.

When beam 190 undergoes total internal reflection at phase-shifting coating 136 on side surface 116, p- and s-polarization components of beam 190 with respect to side surface 116 undergo different respective phase shifts. Phase-shifting coating 136 is configured such that the relative phase shift between the p- and s-polarization components results in a reciprocal polarization rotation of a particular magnitude. In certain embodiments, this reciprocal polarization rotation is 45 degrees in the opposite direction than that of the non-reciprocal polarization rotation in Faraday crystal 120, such that the reciprocal and non-reciprocal polarization rotations of beam 190 cancel each other to yield a net-zero overall polarization rotation of beam 190 in Faraday isolator 100. (In other words, Faraday crystal 120 and the total internal reflection impose mutually-cancelling polarization rotations in these embodiments.) In the absence of phase-shifting coating 136, the relative phase shift between p- and s-polarization components resulting from total internal reflection at side surface 116 is, in most scenarios, insufficient to rotate the polarization of beam 190 by 45 degrees.

Phase-shifting coating 136 may be a single layer of one material, e.g., a metal oxide. In certain embodiments, the side of this single layer facing away from solid block 110 interfaces with air, another gas, or vacuum, so as to limit the magnitude of any beam shift caused by the Goos-Hänchen effect.

Total internal reflection at side surface 116 directs beam 190 to output surface 114, where beam 190 leaves solid block 110 and passes through polarizing coating 134. Polarizing coating 134 is configured to transmit beam 190 and reject the orthogonal polarization. Each of polarizing coatings 132 and 134 may be a multilayer dielectric coating.

In most embodiments, surfaces 112, 114, and 116 are planar so as not to affect the focusing properties of beam 190. However, one or more of surfaces 112, 114, and 116 may be curved to, e.g., focus beam 190, although such curvature may complicate the designs of any associated coatings. Hereinafter, surfaces 112, 114, and 116 are assumed to be planar. Also, in most embodiments, surfaces 112, 114, and 116 are external surface of solid block 110 that, apart from coatings 132, 134, and 136 and mounting hardware, interface with air, another gas, or vacuum. In one implementation, the mounting hardware holding solid block 110 is magnet 170 or a housing that also contains magnet 170.

In one implementation, and associated operation scenario, surfaces 112, 114, and 116 are orthogonal to the plane of FIG. 1, and beam 190 is p-polarized with respect to its incidence on input surface 112. Polarizing coating 132 is configured to transmit this p-polarized beam 190 and reject s-polarized beam components. Such s-polarized components may be in the form of a back-reflected component of beam 190 incident on polarizing coating 132 from inside solid block 110 or polarization impurities/errors in forward propagating beam 190. During propagation from input surface 112 to side surface 116, Faraday crystal 120 rotates the polarization of beam 190 by 22.5 degrees, whereby beam 190 contains both p- and s-polarization components with respect to side surface 116. This mixture of p- and s-polarization components allows for the total internal reflection at phase-shifting coating 136 on side surface 116 to rotate the polarization of beam 190. In the present example, the total internal reflection rotates the polarization by 45 degrees in the opposite direction from the Faraday rotation in Faraday crystal 120. Next, beam 190 passes through Faraday crystal 120 on the way to output surface 114. This second, forward pass through Faraday crystal 120 results in additional polarization rotation by 22.5 degrees in the same direction as for the first pass through Faraday crystal 120, such that beam 190 is p-polarized with respect to output surface 114. Polarizing coating 134 is configured to transmit this p-polarized beam 190 and reject s-polarized beam components.

Faraday isolator 100 is not limited to p-polarized input beams. Faraday isolator 100 may accept laser beams of other polarizations. For example, beam 190 may be s-polarized with respect to its incidence on input surface 112. p-polarized input beams may benefit from zero Fresnel loss if incident on polarizing coating 132 at Brewster's angle. An incident beam of a different polarization may suffer a Fresnel loss, or Faraday isolator 100 may further include an antireflective coating stacked on polarizing coating 132.

When compared to a conventional polarization-dependent Faraday isolator, polarizing coatings 132 and 134 replace polarizers, and phase-shifting coating 136 replaces a half-wave plate. By implementing these elements as coatings 132, 134, and 136 on solid block 110, Faraday isolator 100 is in the form of a single solid object. This is advantageous for at least these two reasons: Aligning a single optical element is easier that aligning four separate optical elements, and it is possible to integrate the polarizing and polarization-rotating optical functions in a small package. The compactness of solid block 110 is primarily limited by the fact that the propagation path through Faraday crystal 120 needs to be long enough for the Faraday effect to produce a 45-degree polarization rotation of beam 190. In one example, the largest dimension of solid block 110 is no more than 20 millimeters (mm). In dimensions orthogonal to the axis of magnetic field 172, solid block 110 may be as small as 5 mm, or less, while accommodating a laser beam 190 with a beam size of up to at least 2 mm, e.g., in the range between 0.1 and 1 mm. This small size of solid block 110 also reduces the requirements of magnet 170. For example, in embodiments where solid block 110 is disposed inside a bore of magnet 170, a smaller size of solid block 110 allows for a smaller bore size of the magnet 170. With a smaller bore size, the magnetic field strength required in Faraday crystal 120 may be achieved with a smaller and less powerful magnet, thereby providing additional advantages in terms of compactness.

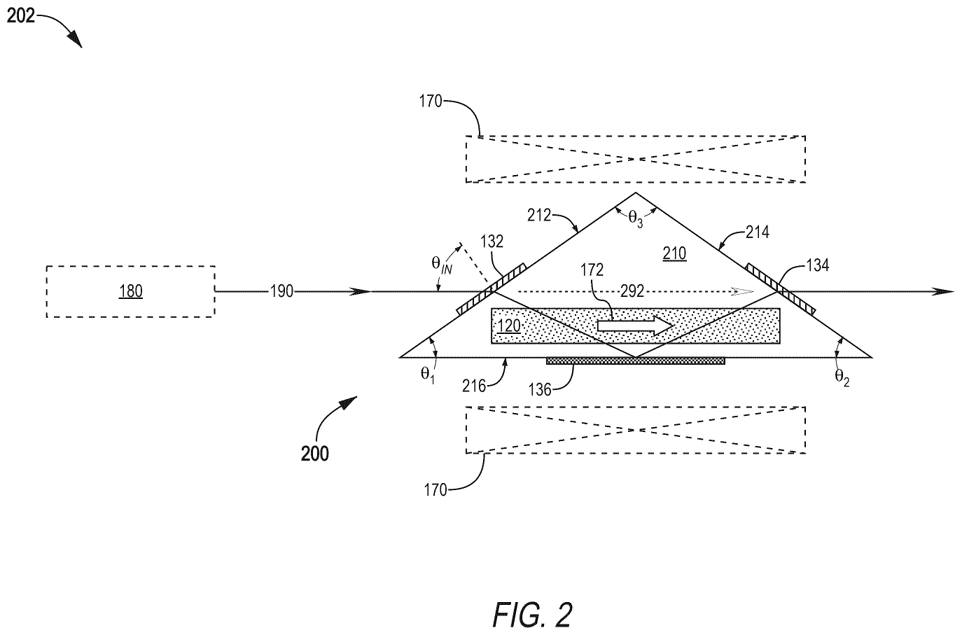

FIG. 2 schematically illustrates, in cross-sectional view, another polarization-dependent Faraday isolator 200 that implements the polarizing and polarization-rotating optical elements as a single solid block with coatings. Faraday isolator 200 is an embodiment of Faraday isolator 100 that is configured to operate with colinear input and output laser beams. Faraday isolator 200 can therefore be placed in an existing laser beam path without disturbing this beam path. Faraday isolator 200 includes a solid block 210 having an input surface 212, an output surface 214, and a side surface 216, which are respective embodiments of surfaces 112, 114, and 116 of solid block 110. Polarizing coatings 132 and 134 are disposed on input surface 212 and output surface 214, respectively. Phase-shifting coating 136 is disposed on side surface 216. Solid block 210 is an embodiment of solid block 110 wherein input surface 212 and output surface 214 are oriented at respective acute angles θ₁ and θ₂ to side surface 216. Acute angles θ₁ and θ₂ are internal angles, that is, angles subtending the interior of solid block 210.

Faraday isolator 200 may be implemented in a laser apparatus 202 that further includes laser source 180. In operation, beam 190 is refracted at input surface 212 and at output surface 214. Beam 190 is incident on polarizing coating 132 on input surface 212 along a propagation direction that is parallel to side surface 216. This results in an oblique incidence angle θ_{IN}. In certain embodiments, θ_{IN} exceeds 45 degrees for optimal performance of polarizing coating 132, whereby angle θ₁ is less than 45 degrees. In such embodiments, angles θ₁ and θ₂ may both be less than 45 degrees, while angle θ₃ between surfaces 212 and 214 is greater than 90 degrees. θ_{IN} may, advantageously, equal Brewster's angle so as to eliminate or at least minimize the Fresnel loss when beam 190 is p-polarized with respect to its incidence on input surface 112. Refraction at input surface 212 directs beam 190 toward side surface 216. Arrow 292 shows how beam 190 would have continued its propagation in the absence of Faraday isolator 200. Refraction of beam 190 at output surface 214 returns beam 190 to a continuation of this propagation path of beam 190. Since solid block 210 may be composed entirely of Faraday crystal 120, the path of beam 190 through Faraday crystal 120 in the FIG. 2 example is depicted only schematically. Specifically, FIG. 2 does not show refraction of beam 190 at the depicted example of Faraday crystal 120.

In certain embodiments of Faraday isolator 200, acute angles θ₁ and θ₂ are identical, Faraday crystal 120 is positioned symmetrically between input surface 212 and output surface 214, and beam 190 reaches side surface 216 at the midpoint of its propagation path between input surface 212 and output surface 214. In one such embodiment, solid block 210 is composed entirely of Faraday crystal 120.

Without departing from the scope hereof, portions of the depicted solid block 210 not intersected by beam 190 may be omitted. For example, one or more of the corners between surfaces 212, 214, and 216 may be truncated to reduce the size of solid block 210.

In a modification of Faraday isolator 200, the input and output beams are parallel but not colinear. For example, if taking the embodiment with colinear input and output beams as the starting point, the length of solid block 210 in the dimension parallel to side surface 216 may be extended while angles θ₁, θ₂ and θ₃ remain the same. This modified embodiment will have parallel input and output beams that are laterally offset from each other.

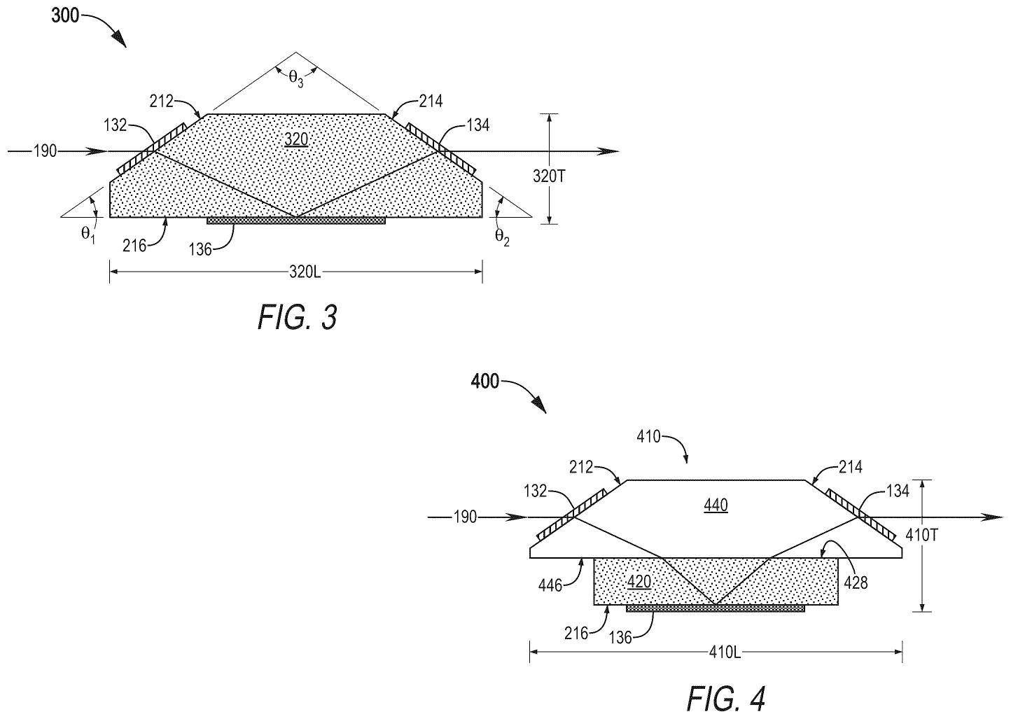

FIG. 3 is a cross section of one polarization-dependent Faraday isolator 300 that implements the polarizing and polarization-rotating optical elements as a monolithic Faraday crystal with coatings. Faraday isolator 300 is an embodiment of Faraday isolator 200, wherein solid block 210 is composed entirely of the Faraday crystal. Although not shown in FIG. 3, Faraday isolator 300 may include magnet 170. In Faraday isolator 300, a Faraday crystal 320 forms surfaces 212, 214, and 216. The corners between surfaces 212, 214, and 216 of Faraday crystal 320 may be truncated as depicted in FIG. 3, or not truncated as shown for solid block 210 in FIG. 2.

In one implementation of Faraday isolator 300, optimized for a design wavelength of 785 nm, Faraday crystal 320 is made of TGG, and phase-shifting coating 136 is made of titanium dioxide. In this implementation, Faraday crystal 320 may have a thickness 320T (orthogonally to side surface 216) of less than 5 mm, a length 320L (along side surface 216) of less than 15 mm, and a width (orthogonally to the plane of FIG. 3) of less than 5 mm. The titanium-dioxide phase-shifting coating may have a thickness of less than 200 nm.

FIG. 4 is a cross section of one polarization-dependent Faraday isolator 400 that implements the polarizing and polarization-rotating optical elements as a composite solid block with coatings. Faraday isolator 400 is an embodiment of Faraday isolator 200, wherein solid block 210 includes both a Faraday crystal 420 and a prism 440. Prism 440 forms input surface 212 and output surface 214. Prism 440 may be made of glass. Faraday crystal 420 forms side surface 216. Faraday crystal 420 further has a side surface 428 that faces away from side surface 216. Side surface 428 of Faraday crystal 420 interfaces with a side surface 446 of prism 440. Preferably, side surface 428 of Faraday crystal 420 is bonded to side surface 446 of prism 440. For this purpose, the interface between surfaces 428 and 446 may include an adhesive. Additionally, the interface between surfaces 428 and 446 may include an antireflective coating. Instead of bonding surfaces 428 and 446 to each other, Faraday crystal 420 and prism 440 may be clamped together or otherwise affixed to each other with mechanical hardware, although this is typically less desirable as the clamping/mechanical hardware adds bulk to the assembly.

Faraday isolator 400 may be optimized for a design wavelength of 785 nm. In one such implementation, prism 440 is made of fused silica, Faraday crystal 420 is made of TGG, and phase-shifting coating 136 is made of titanium dioxide. In this implementation, solid block 410 may have a thickness 410T of less than 5 mm, a length 410L of less than 15 mm, and a width (orthogonally to the plane of FIG. 4) of less than 5 mm. The titanium-dioxide phase-shifting coating may have a thickness of less than 100 nm. In another implementation optimized for a design wavelength of 785 nm, prism 440 is made of fused silica, Faraday crystal 420 is made of CMT, and phase-shifting coating 136 is made of hafnium dioxide. In this implementation, a thinner Faraday crystal 420 suffices. Thus, in this CMT-based implementation, solid block 410 may have a thickness 410T of less than 3 mm, a length 410L of less than 12 mm, and a width of less than 5 mm. The hafnium-dioxide phase-shifting coating may have a thickness of less than 50 nm.

Without departing from the scope hereof, Faraday isolator 400 may include an additional element, such as a glass substrate, between Faraday crystal 420 and phase-shifting coating 136. This additional element is, however, not desirable in terms of compactness.

The design of Faraday isolator 100 is extendable to more than one total-internal-reflection in the solid block. Increasing the number of total-internal-reflections reduces the relative phase shift, between p- and s-polarized beam components, required at each individual total-internal-reflection to achieve a combined reciprocal polarization rotation of the desired magnitude, e.g., 45 degrees. Additionally, configurations with an even number of total-internal-reflections can offer reduced sensitivity to alignment errors of the solid block with respect to beam 190, as discussed in the following.

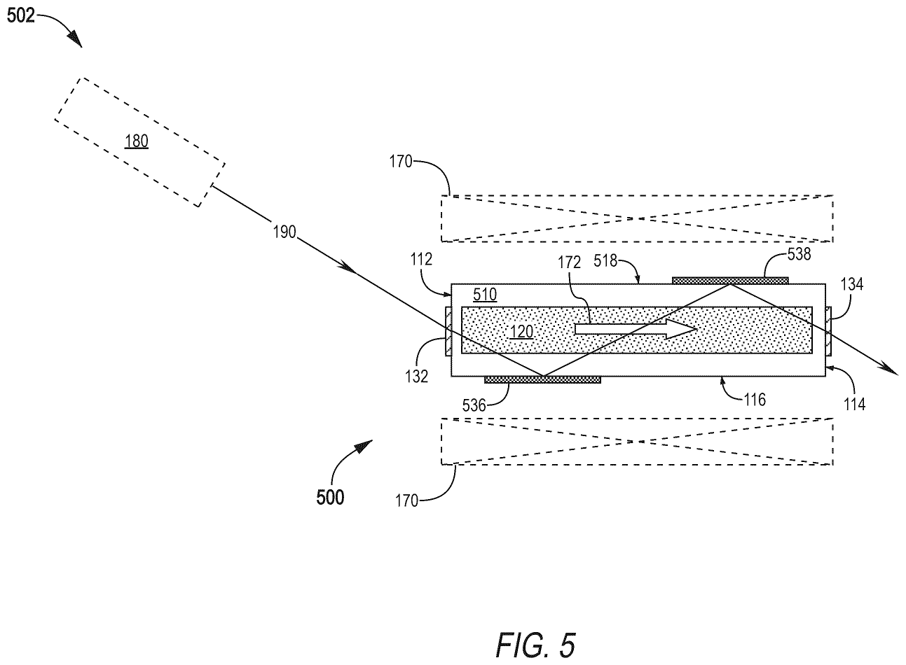

FIG. 5 schematically illustrates one polarization-dependent Faraday isolator 500 that (a) implements the polarizing and polarization-rotating optical elements as a single solid block with coatings and (b) is configured for two total-internal-reflections in the solid block. Faraday isolator 500 is an extension of Faraday isolator 100 to two instead of one total internal reflection. Faraday isolator 500 is similar to Faraday isolator 100 except that solid block 110 is replaced by a solid block 510 configured for two total-internal-reflections. Faraday isolator 500 may be approximately as compact as Faraday isolator 100.

Similarly to solid block 110, solid block 510 includes or is composed of Faraday crystal 120, and forms input surface 112, output surface 114, and side surface 116. Solid block 510 further forms a second side surface 518. Side surfaces 116 and 518 may be opposite-facing, parallel surfaces. Polarizing coatings 132 and 134 are disposed on input surface 112 and output surface 114, respectively, of solid block 510. Faraday isolator 500 further includes phase-shifting coatings 536 and 538 disposed on side surfaces 116 and 518, respectively. Each of phase-shifting coatings 536 and 538 may be similar to phase-shifting coating 136, except for, at least in some embodiments, being configured to impose a smaller relative phase shift between p- and s-polarized beam components for each reflection.

FIG. 5 shows Faraday isolator 500 as being implemented in a laser apparatus 502 that includes laser source 180. In operation, beam 190 from laser source 180 enters solid block 510 at input surface 112, propagates from input surface 112 to side surface 116, and undergoes total internal reflection at side surface 116 as in solid block 110 of Faraday isolator 100. Total internal reflection at side surface 116 directs beam 190 to side surface 518. Here, beam 190 undergoes a second total-internal-reflection that directs beam 190 to output surface 114. The two total-internal-reflections, at side surfaces 116 and 518, respectively, cooperate to impose the desired amount of reciprocal polarization rotation on beam 190. In certain embodiments, the two total-internal-reflections rotate the polarization of beam 190 by 45 degrees.

In embodiments where input surface 112 and output surface 114 are parallel to each other and side surfaces 116 and 518 are parallel to each other, the input and output beam paths may be parallel. That is, beam 190 may emerge from polarizing coating 134 with a propagation direction that is parallel to the propagation of beam 190 when initially incident on polarizing coating 132.

Faraday isolator 500 is readily extendable to embodiments where solid block 510 is configured for three or more total-internal-reflections.

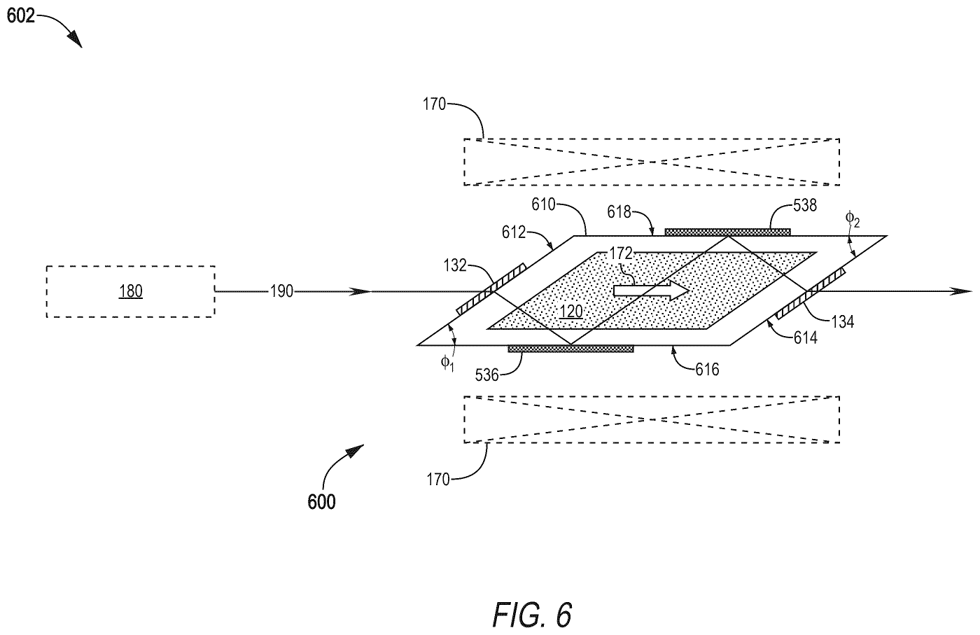

FIG. 6 schematically illustrates, in cross-sectional view, another polarization-dependent Faraday isolator 600 that implements the polarizing and polarization-rotating optical elements as a single, coated solid block configured for two total-internal-reflections. FIG. 6 shows Faraday isolator 600 as being implemented in a laser apparatus 602 that includes laser source 180.

Faraday isolator 600 is an embodiment of Faraday isolator 500 that is configured to operate with colinear input and output laser beams. For this purpose, Faraday isolator 600 implements solid block 510 as a solid block 610 that forms an input surface 612, an output surface 614, and two side surfaces 616 and 618. Surfaces 612, 614, 616, and 618 are embodiments of surfaces 112, 114, 116, and 518 of solid block 510. Input surface 612 is oriented at an acute angle ϕ₁ to side surface 616, and output surface 614 is oriented at an acute angle ϕ₂ to side surface 618. Acute angles ϕ₁ and ϕ₂ are internal angles. Solid block 610 refracts beam 190 such that beam 190 emerges from polarizing coating 134 at output surface 614 on a propagation path that is parallel to or even colinear (as depicted) with the initial propagation path of beam 190 when incident on polarizing coating 132 on input surface 612.

In the depicted embodiment of Faraday isolator 600, acute angles ϕ₁ and ϕ₂ are identical, such that solid block 610 is rhomb-shaped, and Faraday crystal 120 is positioned symmetrically between input surface 612 and output surface 614. This embodiment of Faraday isolator 600 makes laser apparatus 602 relatively tolerant to misalignment of solid block 610. For example, in embodiments with colinear input and output beams, the colinear input and output beam paths are maintained even if solid block 610 is translated or rotated (at least within certain limits) with respect to its nominal position and orientation in beam 190.

The oblique incidence angle of beam 190 onto polarizing coating 132 on input surface 612 results in the same advantages as discussed above in reference to FIG. 2 and Faraday isolator 200. As also discussed for Faraday isolator 200, portions of the depicted solid block 610 of Faraday isolator 600 not intersected by beam 190 may be omitted. For example, one or more of the corners between surfaces 612, 614, 616, and 618 may be truncated to reduce the size of solid block 610.

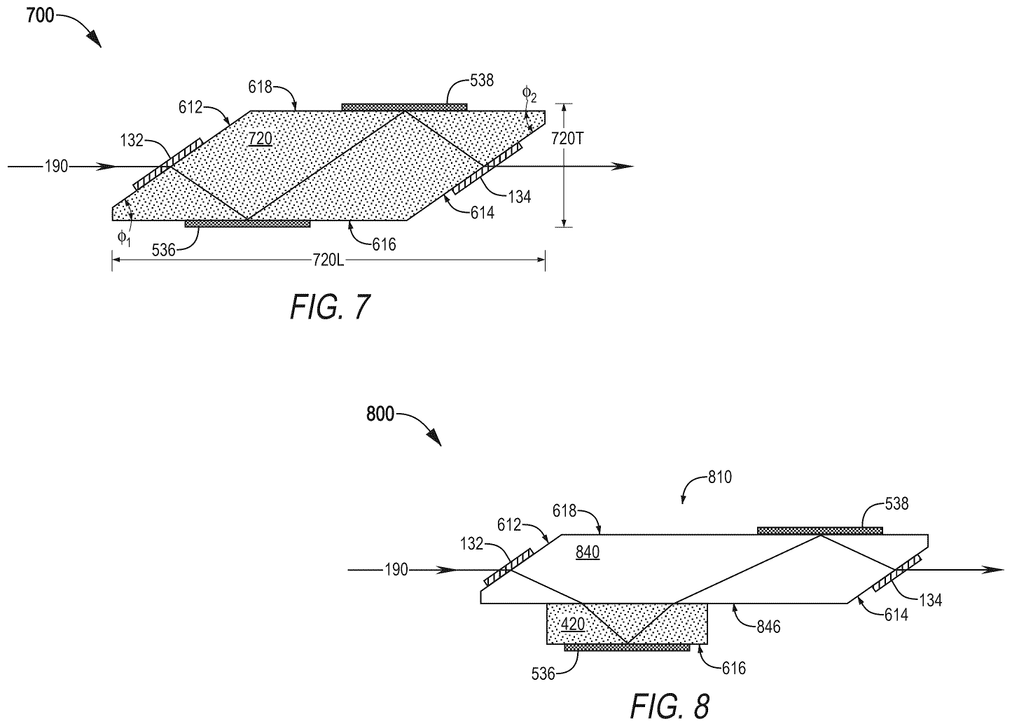

FIG. 7 is a cross section of one polarization-dependent Faraday isolator 700 that implements the polarizing and polarization-rotating optical elements as a coated, rhomb-shaped Faraday crystal configured for two total-internal-reflections. Faraday isolator 700 is an embodiment of Faraday isolator 600, wherein solid block 610 is composed entirely of a Faraday crystal 720, and acute angles @1 and ϕ₂ are identical. Although not shown in FIG. 7, Faraday isolator 700 may include magnet 170. Faraday crystal 720 forms surfaces 612, 614, 616, and 618. The corners between surfaces 612, 614, 616, and 618 of Faraday crystal 720 may be truncated as depicted in FIG. 7, or not truncated as shown for solid block 610 in FIG. 6.

In one implementation of Faraday isolator 700, optimized for a design wavelength of 785 nm, Faraday crystal 720 is made of TGG, and phase-shifting coatings 536 and 538 are made of titanium dioxide. In this implementation, Faraday crystal 720 may have thickness 720T, length 720L, and width similar to the corresponding dimensions of Faraday crystal 220 of Faraday isolator 200, and each of the two titanium-dioxide phase-shifting coatings may be less than 100 nm thick.

Faraday isolator 700 may be extended to a greater, even number of total-internal-reflections than two, while maintaining similar advantages as those discussed above for two total-internal-reflections.

FIG. 8 is a cross section of one polarization-dependent Faraday isolator 800 that implements the polarizing and polarization-rotating optical elements as a coated, composite solid block configured for two total-internal-reflections. Faraday isolator 800 is an embodiment of Faraday isolator 600 implementing a solid block 810 that includes both Faraday crystal 420 (see FIG. 4) and a rhomb 840. Rhomb 840 forms input surface 612, output surface 614, and side surface 618 and further has a side surface 846. Rhomb 840 may be made of glass. Faraday crystal 420 forms side surface 616 and is disposed on side surface 846 of rhomb 840. Faraday crystals 420 may be bonded to or otherwise held in contact with rhomb 840, as discussed above for Faraday crystal 420 and prism 440 of Faraday isolator 400.

Faraday isolator 800 also corresponds to an extension of Faraday isolator 400 to two total-internal-reflections. Faraday isolator 800 may utilize similar materials as Faraday isolator 400.

The present invention is described above in terms of a preferred embodiment and other embodiments. The invention is not limited, however, to the embodiments described and depicted herein. Rather, the invention is limited only by the claims appended hereto.

What is claimed is:

1. A polarization-dependent Faraday isolator, comprising:
a solid block that has an input surface, an output surface, and a first side surface and includes a Faraday crystal;
a polarizing input-coating disposed on the input surface;
on the first side surface, a phase-shifting coating to introduce a phase shift between s-polarized and p-polarized components of a laser beam, with respect to the first side surface, when the laser beam undergoes total internal reflection at the first side surface; and
a polarizing output-coating disposed on the output surface.

2. The polarization-dependent Faraday isolator of claim 1, wherein a largest dimension of the solid block is no more than 20 millimeters.

3. A laser apparatus, comprising:
a laser source to generate a laser beam; and
the polarization-dependent Faraday isolator of claim 1, the solid block being arranged such that (a) the laser beam enters the solid block via the input surface and leaves the solid block via the output surface and (b) a propagation path of the laser beam after emerging from the polarizing output-coating on the output surface is parallel to a propagation path of the laser beam incident on the polarizing input-coating on the input surface.

4. The laser apparatus of claim 3, wherein the solid block is shaped such that the propagation path of the laser beam after emerging from the polarizing output-coating on the output surface is colinear with the propagation path of the laser beam incident on the polarizing input-coating on the input surface.

5. The polarization-dependent Faraday isolator of claim 1, wherein the input surface, output surface, first side surface, and Faraday crystal are arranged such that a laser beam incident on the polarizing input-coating on the input surface with a propagation direction parallel to the first side surface (a) propagates from the input surface to the first side surface via the Faraday crystal, (b) undergoes total internal reflection at the phase-shifting coating on the first side surface, (c) propagates from the first side surface to the output surface via the Faraday crystal, and (d) leaves the solid block at the output surface and passes through the polarizing output-coating.

6. A laser apparatus, comprising:
the polarization-dependent Faraday isolator of claim 5;
a laser source to generate the laser beam; and
a magnet to generate a magnetic field in the Faraday crystal;
wherein:
the polarizing input-coating selectively transmits one linear polarization component of the laser beam,
the magnet and Faraday crystal cooperatively rotate the linear polarization component by 45 degrees in a first direction,
the total internal reflection at the phase-shifting coating on the first side surface rotates the linear polarization component of the laser beam by 45 degrees in a second direction that is opposite the first direction, whereby the total internal reflection and Faraday crystal impose mutually-cancelling polarization rotations on the laser beam, and
the polarizing output-coating selectively transmits the same linear polarization component as the polarizing input-coating.

7. The laser apparatus of claim 6, wherein the Faraday isolator is arranged such that the laser beam is incident on the polarizing input-coating at Brewster's angle.

8. The laser apparatus of claim 6, wherein the solid block is shaped such that a propagation path of the laser beam after emerging from the polarizing output-coating on the output surface is parallel to a propagation path of the laser beam incident on polarizing input-coating on the input surface.

9. The polarization-dependent Faraday isolator of claim 1, wherein the input surface, output surface, and first side surface are planar and orthogonal to a common plane.

10. The polarization-dependent Faraday isolator of claim 1, wherein the phase-shifting coating includes titanium dioxide or hafnium oxide.

11. The polarization-dependent Faraday isolator of claim 1, wherein the solid block consists of the Faraday crystal.

12. The polarization-dependent Faraday isolator of claim 1, wherein the input surface is oriented at a first acute angle to the first side surface, and the output surface is oriented at a second acute angle to the first side surface, each of the first and second acute angles subtending an interior of the solid block.

13. The polarization-dependent Faraday isolator of claim 12, wherein the second acute angle equals the first acute angle.

14. The polarization-dependent Faraday isolator of claim 12, wherein:
the Faraday crystal forms the first side surface and further has a second side surface facing away from the first side surface; and
the solid block is a composite block further including a prism forming the input and output surfaces, the prism further having a third side surface interfacing with the second side surface of the Faraday crystal.

15. The polarization-dependent Faraday isolator of claim 14, wherein the first and second side surfaces are planar and mutually parallel.

16. The polarization-dependent Faraday isolator of claim 14, wherein third side surface is bonded to the second side surface.

17. The polarization-dependent Faraday isolator of claim 1, wherein the solid block further has a second side surface, and wherein the Faraday isolator further comprises a phase-shifting coating disposed on the second side surface.

18. The polarization-dependent Faraday isolator of claim 17, wherein the first and second side surfaces are parallel to each other and the input surface, output surface, first side surface, second side surface, and Faraday crystal are arranged such that a laser beam incident on the polarizing input-coating on the input surface (a) propagates from the input surface to the first side surface via through the Faraday crystal, (b) undergoes total internal reflection at the phase-shifting coating on the first side surface, (c) propagates from the first side surface to the second side surface via the Faraday crystal, (d) undergoes total internal reflection at the phase-shifting coating on the second side surface, (e) propagates from the second side surface to the output surface via the Faraday crystal, and (f) leaves the solid block at the output surface and passes through the polarizing output-coating.

19. A laser apparatus, comprising:
the polarization-dependent Faraday isolator of claim 18;
a laser source to generate the laser beam; and
a magnet to generate a magnetic field in the Faraday crystal;
wherein:
the polarizing input-coating selectively transmits one linear polarization component of the laser beam,
the magnet and Faraday crystal cooperatively rotate the linear polarization component by 45 degrees in a first direction,
the total internal reflections at the phase-shifting coatings, on the first and second side surfaces, respectively, cooperate to rotate the linear polarization component of the laser beam by a total of 45 degrees in a second direction that is opposite the first direction, whereby the total internal reflections and Faraday crystal impose mutually-cancelling polarization rotations on the laser beam, and
the polarizing output-coating selectively transmits the same linear polarization component as the polarizing input-coating.

20. The laser apparatus of claim 19, wherein the Faraday isolator is arranged such that the laser beam is incident on the polarizing input-coating at Brewster's angle.

21. The laser apparatus of claim 19, wherein the solid block is configured such that a propagation path of the laser beam immediately after leaving the polarizing output-coating on the output surface is parallel to a propagation path of the laser beam incident on polarizing input-coating on the input surface.

22. The polarization-dependent Faraday isolator of claim 17, wherein the solid block consists of the Faraday crystal.

23. The polarization-dependent Faraday isolator of claim 17, wherein the input surface is oriented at a first acute angle to the first side surface, the first acute angle subtending an interior of the solid block.

24. The polarization-dependent Faraday isolator of claim 23, wherein the first and second side surfaces are mutually opposite-facing, and the output surface is oriented at a second acute angle to the second side surface, the second acute angle subtending an interior of the solid block.

25. The polarization-dependent Faraday isolator of claim 24, wherein the first side surface is parallel with the second side surface, and the input surface is parallel with the output surface.
